(19) United States
(12) Patent Application Publication
(10) Pub. No.: US 2016/0260062 A1
(43) Pub. Date: Sep. 8, 2016

(54) SYSTEM AND METHOD OF PROCESSING DATA

(71) Applicant: Angela D. Ellington, Savannah, GA (US)

(72) Inventor: Angela D. Ellington, Savannah, GA (US)

(21) Appl. No.: 15/061,471

(22) Filed: Mar. 4, 2016

Related U.S. Application Data
(60) Provisional application No. 62/128,230, filed on Mar. 4, 2015.

(51) Int. Cl. G06Q 10/10; G06F 17/30

(52) U.S. Cl. CPC G06Q 10/101; G06F 17/30867

(57) ABSTRACT

There is a system and method of processing data using a computing device. The system includes a collection module for collecting product data regarding one or more product formulations according to one or more attributes. The system includes an identification module for identifying whether the collected data is instrumental data or human-descriptive data. The system includes a tagging module for tagging the collected product data with a tag based on whether it is instrumental data or human-descriptive data. The system includes an association module for associating demographic information with the selected product data. The system includes a search module for searching for a best match for the collected data from a data pool storing trained/untrained, attributes, instrumental, human-descriptive and demographic data.

### CROSS-REFERENCE TO RELATED APPLICATIONS

This invention claims priority, under 35 U.S.C. §120, to the U.S. Provisional Patent Application No. 62/128,230 to Angela D. Ellington filed on Mar. 4, 2015, which is incorporated by reference herein.

### BACKGROUND OF THE INVENTION

1. Field of the Invention

The present invention relates to technical translation systems and methods, specifically a system and method of processing data.

2. Description of the Related Art

Product development, especially in the field of cosmetic products, generally requires a great deal of research in order to generate products that meet the wants and needs of consumers. Further, those best suited to develop, revise and refine chemical compositions and the like are typically highly skilled and trained individuals who operate, amongst each other, according to a very specialized and typically very precise set of nomenclature designed to allow them to easily and effectively communicate clear ideas with consistency.

On the opposite end of this spectrum are consumers themselves. Consumers tend to use whatever nomenclature is convenient to them. They do not have a unified way of communicating. In addition, their perspective with regard to the products that they use also includes their opinions, tendencies, preferences, likes/dislikes and the like, which are often extremely subjective, especially as compared to the types of communications made by the specialized experts.

Accordingly, it is difficult for experts to effectively communicate with the general public and vice-versa. Accordingly, these difficulties result in inefficiencies in the product development process, as it is hard for developers to communicate benefits and features properly to consumers (even to focus group participants, etc.) and it is hard for consumers to communicate needs and wants to the developers.

Similar problems exists in other contexts as well, such as but not limited to how it is difficult for older people to understand what the younger generations say when they use their particular idioms/etc. Techniques for effectively “translating” within a language may be used to reduce such problems. These often include “dumbing down” technical information and/or educating consumers about specific technical realities. The popular brand of “Dummies” books is an example of various attempts to bridge communication gaps between experts and the lay person. Another example are websites, like the Urban Dictionary, that provide explanations regarding various terms and phrases that might not otherwise be found in a standard dictionary.

Some improvements have been made in the field. Examples of references related to the present invention are described below in their own words, and the supporting teachings of each reference are incorporated by reference herein:

U.S. Pat. No. 8,739,031, issued to Cheung et al., discloses a system and method for translating received input from a sender to recipient in an instant messaging dialog is disclosed. The method comprises receiving instant messaging input from a sender for recipient, wherein the instant messaging input comprises at least one subculture specific term. A category is identified the defines a difference between the sender and the recipient and the received instant messaging input is modified from the sender by generating an output associated with the least one subculture specific term and based on the identified category. Multiple recipients in a chat session may also each receive a translated or annotated message according to characteristics of each individual recipient.

U.S. Pat. No. 7,567,917, issued to Miller et al., discloses an invention that captures information associated with a manufacturer, the manufacturer's competitors and consumers in order to improve new product and packaging design match consumer needs with the manufacturer's capabilities and competitor strengths. Raw data are translated into actionable information that is used for strategic direction of product and packaging design and development.

U.S. Pat. No. 8,806,061, issued to Lobo et al., discloses a system, method, and computer program product to enable component providers to submit components, along with associated metadata for the component, to a service brokerage system. This allows the brokerage to automatically categorize the component and enables the assembly of the components into services.

U.S. Patent Application Publication No.: 2011/0047149, by Vaananen, discloses an invention that relates to data searching and translation. In particular, the invention relates to searching documents from the Internet or databases. Even further, the invention also relates to translating words in documents, WebPages, images or speech from one language to the next. A computer implemented method including at least one computer in accordance with the invention is characterized by the following steps: receiving a search query including at least one search term, deriving at least one synonym for at least one search term, expanding the received search query with the at least one synonym, searching at least one document using the expanded search query, retrieving the search results obtained with the expanded query, ranking the search results based on context of occurrence of at least one search term. The best mode of the invention is considered to be an Internet search engine that delivers better search results.

The inventions heretofore known suffer from a number of disadvantages, including but not limited to one or more of: not facilitating making/designing consumer products, not facilitating making/designing improved consumer products, not being customized, failing to respect diversity in consumer groups, being expensive, not increasing the probability of continued use of products, not enabling the generation of better/more accurate marketing materials, failing to suggest marketing/consumer language, failing to suggest consumer perception of product types/categories, failing to suggest additional product types/categories, failing to eliminate wasteful SKUs, failing to create opportunities for targeted formulations, and failing to allow stylists to generate customized suggestions for products.

What is needed is a system and method of processing data that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available systems and methods of processing data. Accordingly, the present invention has been developed to provide an efficient and effective way for product developers and consumers to communicate to analyze a consumer product over a computerized network.

According to one embodiment of the invention, there is a method of processing data using a computing device. The method may include the step of collecting product data regarding one or more product formulations according to one or more attributes and associating that product data with corresponding product formulations and attributes, wherein the attributes correspond to attribute categories stored in a computing device. The step of collecting product data may include collecting instrumental data and further comprising the steps of: producing a plurality of product formulations on which instrumental data is collected; and automatically reporting best match data in a comparison format for the plurality of product formulations.

The method of processing data using a computing device may include the step of identifying whether the collected product data is instrumental data or human-descriptive data. The method may include the step of tagging the collected product data with a tag based on whether it is instrumental data or human-descriptive data.

The method of processing data using a computing device may include the step of associating consumers' assessment and their demographic information with the collected product data. The step of associating demographic information may include the step of selecting demographic information if it is instrumental data and collecting demographic information if it is human-descriptive data. Demographic information may include but not limited to ethnicity, cultural association, race, location, age, and gender. The method may include associating a trained or un-trained human descriptor with the collected product data. The method may include the step of searching for similarities within collected data in a data pool storing trained/un-trained consumer assessments, instrumental analysis, human descriptors and demographic data.

The method of processing data using a computing device may include the step of automatically reporting the best match. The method may include the step of generating the data pool by surveying a group of people with respect to their trained/un-trained descriptions related to specific attributes. The method may include the step of reporting together with the best match an alternative match that is the alternative of trained/un-trained.

According to one embodiment of the invention, there is a system of processing data using a computing device. The system may include a collection module for collecting product data regarding one or more product formulations according to one or more attributes. The system may include an identification module for identifying whether the collected data is instrumental data or human-descriptive data. The system may include a tagging module for tagging the collected product data with a tag based on whether it is instrumental data or human-descriptive data;

The system of processing data using a computing device may include an association module for associating demographic information with the selected product data. The system may include a search module for searching for similarities for the collected data from a data pool storing trained/un-trained, attributes, instrumental, human descriptive and demographic data. The system may include a report module for reporting similarities.

The system of processing data using a computing device may include a generation module for generating the data pool by surveying a group of people with respect to their trained/untrained description related to specific attributes. The system may include a perception storage module for tracking and storing consumer perceptions during use of the system. The system may include a product data storage module for tracking and storing instrumental data. The system may include an analysis module for analyzing and generating reports for trained and untrained consumers. The system may include an account module for tracking records of consumers using the system.

According to one embodiment of the invention, there is a method of processing data, using a processor, over a computerized network. The method may include the step of developing a consumer product formulation. The method may include the step of testing the consumer product formulation to obtain instrumental data therefrom. The method may include gathering human-descriptive data from consumers such that the human-descriptive data is associated with instrumental data categories. The method may include the step of gathering demographic data from consumers from which human-descriptive data is gathered. The method may include the step of associating human-descriptive data with the obtained instrumental data and the demographic data, thereby generating consumer profile data. The method may include storing the consumer profile data.

The method of processing data, using a processor, over a computerized network may include the step of processing a second consumer product through a system of processing data, including a collection module for collecting product data regarding one or more product formulations according to one or more attributes; The collecting product data may include collecting instrumental data and further may comprise the steps of producing a plurality of product formulations on which instrumental data is collected; and automatically reporting similar data in a comparison format for the plurality of product formulations.

The method of processing data, using a processor, over a computerized network may include an identification module for identifying whether the collected data is instrumental data or human-descriptive data; a tagging module for tagging the collected product data with a tag based on whether it is instrumental data or human-descriptive data.

The method of processing data, using a processor, over a computerized network may include an association module for associating demographic information with the selected product data. The step of associating demographic information may include the step of selecting demographic information if it is instrumental data and collecting demographic information if it is human-descriptive data

The method of processing data, using a processor, over a computerized network may include a search module for searching for a best match for the collected data from a data pool, which includes the consumer profile data, matching trained/un-trained, attributes, instrumental, human descriptive and demographic data.

The method of processing data, using a processor, over a computerized network may include the step of generating and reviewing reports on a consumer product based on best match data from the system of processing data. The method may include the step of automatically reporting the best match.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a network diagram of a system of processing data using a computing device, according to one embodiment of the invention;

FIG. 2 is a module diagram of a system of processing data using a computing device, according to one embodiment of the invention;

FIG. 3 is a method of processing data using a computing device, according to one embodiment of the invention;

FIG. 4 is a method of processing data using a computing device, according to one embodiment of the invention; and

FIG. 5 is a sequence diagram of a method of processing data using a computing device, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Many of the functional units described in this specification have been labeled as modules in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. Modules may also be implemented in software for execution by various types of processors. An identified module of programmable or executable code may, for instance, comprise one or more physical or logical blocks of computer instructions which may, for instance, be organized as an object, procedure, or function.

Nevertheless, the executables of an identified module need not be physically located together, but may comprise disparate instructions stored in different locations which, when joined logically together, comprise the module and achieve the stated purpose for the module. Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The various system components and/or modules discussed herein may include one or more of the following: a host server, motherboard, network, chipset or other computing system including a processor for processing digital data; a memory device coupled to a processor for storing digital data; an input digitizer coupled to a processor for inputting digital data; an application program stored in a memory device and accessible by a processor for directing processing of digital data by the processor; a display device coupled to a processor and/or a memory device for displaying information derived from digital data processed by the processor; and a plurality of databases including memory device(s) and/or hardware/software driven logical data storage structure(s).

Various databases/memory devices described herein may include records associated with one or more functions, purposes, intended beneficiaries, benefits and the like of one or more modules as described herein or as one of ordinary skill in the art would recognize as appropriate and/or like data useful in the operation of the present invention.

As those skilled in the art will appreciate, any computers discussed herein may include an operating system, such as but not limited to: Android, iOS, BSD, IBM z/OS, Windows Phone, Windows CE, Palm OS, Windows Vista, NT, 95/98/2000, OS X, OS2; QNX, UNIX; GNU/Linux; Solaris; MacOS; and etc., as well as various conventional support software and drivers typically associated with computers. The computers may be in a home, industrial or business environment with access to a network. In an exemplary embodiment, access is through the Internet through a commercially-available web-browser software package, including but not limited to Internet Explorer, Google Chrome, Firefox, Opera, and Safari.

The present invention may be described herein in terms of functional block components, functions, options, screen shots, user interactions, optional selections, various processing steps, features, user interfaces, and the like. Each of such described herein may be one or more modules in exemplary embodiments of the invention even if not expressly named herein as being a module. It should be appreciated that such functional blocks and etc. may be realized by any number of hardware and/or software components configured to perform the specified functions. For example, the present invention may employ various integrated circuit components, e.g., memory elements, processing elements, logic elements, scripts, look-up tables, and the like, which may carry out a variety of functions under the control of one or more microprocessors or other control devices. Similarly, the software elements of the present invention may be implemented with any programming or scripting language such as but not limited to Eiffel, Haskell, C, C++, Java, Python, COBOL, Ruby, assembler, Groovy, PERL, Ada, Visual Basic, SQL Stored Procedures, AJAX, Bean Shell, and extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention may detect or prevent security issues with a client-side scripting language, such as JavaScript, VBScript or the like.

Additionally, many of the functional units and/or modules herein are described as being “in communication” with other functional units, third party devices/systems and/or modules. Being “in communication” refers to any manner and/or way in which functional units and/or modules, such as, but not limited to, computers, networks, mobile devices, program blocks, chips, scripts, drivers, instruction sets, databases and other types of hardware and/or software, may be in communication with each other. Some non-limiting examples include communicating, sending, and/or receiving data and metadata via: a wired network, a wireless network, shared access databases, circuitry, phone lines, internet backbones, transponders, network cards, busses, satellite signals, electric signals, electrical and magnetic fields and/or pulses, and/or so forth.

As used herein, the term “network” includes any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using other protocols, including but not limited to IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

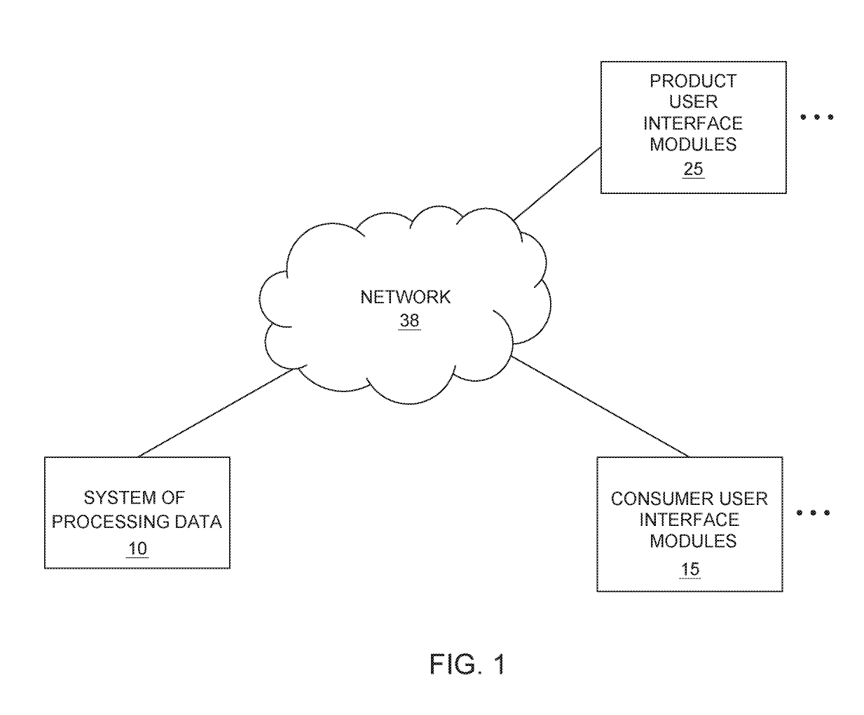

FIG. 1 is a network diagram of a system of processing data using a computing device, according to one embodiment of the invention. There is shown a system of processing data 10 in communication with a plurality of product user interface modules 25 and a plurality of consumer user interface modules 15 over a computerized network 38.

The illustrated system of processing data using a computing device 10. The system 10 collects product data regarding one or more product formulations according to one or more attributes. The product data may be data from one or more sources, such as but not limited to a lab wherein instrumental data is generated, a database, a system for collecting human-descriptive data (e.g. a consumer survey management system), or the like or combinations thereof. The system may automatically collect such data such as but not limited to by querying over a network, manual data entry, an ongoing/real-time data bridge, receiving pushed data, OCR recognition of scanned data, automatically recording and associating instrumental data, and the like and combinations thereof.

The illustrated system 10 identifies whether the collected data is instrumental data or human-descriptive data. The system may do so on intake, such as but not limited to requiring a source of data to identify if the data is instrumental or human-descriptive, or by requiring that the data be presented in a manner than the nature of the data is inherent in the data itself (e.g. it includes units of measurement associated with specific testing, it is presented in a narrative format consistent with human-descriptive data). The system may parse the data and analyze it such that it can determine, by its inherent characteristics, what kind of data it may be. Instrumental data is usually expressed in numbers, either with or without units, and non-limiting examples of instrumental data include but not limited to: viscosity, refractive index, peak combing load, and uptake of compounds. Human descriptive data is usually expressed in words, though may sometimes be expressed in numbers without units so long as context is present, and non-limiting examples of human-descriptive data include: smooth, soft, tangled, thick, hard to use, greasy, dry, I don't like it, moisturizing, feels natural, shiny, 10 out of 10, I loved it, It didn't moisturize my hair Human-descriptive data is generally associated with one or more instrumental data fields relating to how the human descriptive data was obtained. As a non-limiting example, where human descriptive data was obtained on a product by asking individual(s) “How much smoother do you think your hair is after using this conditioner?” would likely be associated with “peak comb load” when stored in the system. Accordingly, the system would have, for the various demographic variations present in the set of people asked that question, how those people express peak comb load associated with the product tested.

The illustrated system 10 tags the collected product data with a tag based on whether it is instrumental data or human-descriptive data. Such may be as simple as changing a field in a record associated with the data such that the field then specifies whether the data is instrumental data or human-descriptive data. Such may also include associating units with the data (e.g. lbs/incĥ2), associating instrumental data types with the data, and/or the like and combinations thereof.

The illustrated system of processing data using a computing device 10 associates demographic information with the selected product data. Such may be as simple as changing a field in a record associated with the data such that the field specifies what demographic data may be associated with that data. Demographic data would be data related to demographic and/or other characteristics associated with the data (e.g. race, ethnicity, geographic location, religion, gender, hair type, skin type, age, occupation, income level) such that the data can be assigned to one or more groups as being data from that group. Generally demographic data is only assigned with respect to human-descriptive data and not to instrumental data unless that instrumental data relates to a specific individual (e.g. instrumental testing done on product applied to an individual, oppose to a hair tresse).

The illustrated system 10 searches for a best match for the collected data from a data pool matching trained/un-trained, attributes, and demographic data while matching the opposite of instrumental and human-descriptive data. The system may do so by querying data stored within the system for the selected characteristics and returning with data that is tagged or otherwise associated with the requested characteristics. As a non-limiting example, a user may select a particular set of collected data and then may use the system to find an alternative manner of presenting that data that is on the opposite side of the expert/lay person way of communicating. The user may collect instrumental data on a product and enter it into the system and then select one or more selections (e.g. trained/untrained, demographic descriptors, attributes) to then find out a likely manner in which that data would be expressed by a person having the selected characteristics. In another non-limiting example, a user may enter data from a particular demographic (e.g. asking a particular group of people what they want out of a conditioner) and use that to find similar stored product data to include instrumental that would suggest a hypothetical product. The user could then produce a variety of product samples that test instrumentally within a range near what the system predicted in order to have a good starting point for producing a product that they intend to market to a particular segment, with the expectation of being able to promote that product, using human-descriptive language, in a predefined manner.

The illustrated system 10 also reports a best match. There may be a scripted report generation module that generates reports according to a format defined by the script therein. The report may include a recitation of the request, the best match found, other similar matches, a score representing how good the match is and the like and combinations thereof. The report may also include other match information, such as but not limited to what matches for adjacent (e.g. similar or sub-categories of demographic data, such as but not limited to sub-regions within a larger region, subdivided age groups, age groups that are numerically near the requested age group) demographic types might be.

The illustrated system of processing data using a computing device 10 generates a data pool by surveying a group of people with respect to their trained/untrained description related to specific attributes. Such may be accomplished by presenting a group of people having various demographic characteristics with a collection of products having various results from instrumental data testing. Some of the group may be trained in what the product attributes and expectations are and what they mean, while others are not. The group is then allowed to experience the products and may be automatically surveyed with regard to the products by being asked questions that will relate data with instrumental testing that has been performed (or that may later be performed). Their answers are then stored within the system in association with the specific test results (instrumental data) of the specific products, thereby creating a foundational database which may be used by the system to respond to product development queries as described herein.

The illustrated system 10 tracks and stores consumer perceptions during use of the system. The system may include one or more automated survey modules to collect and store such information from consumers as the system is involved in the management of focus groups, beta testers, and the like and combinations thereof.

The illustrated system 10 also tracks and stores instrumental data. Such may be accomplished by storing such information in a database, entered thereby through manual data entry, a data bridge, real-time communication with testing equipment and the like and combinations thereof.

The illustrated system 10 analyzes and generates reports for trained and untrained consumers. This may be accomplished by tagging human-descriptive data as being from either a trained or an untrained individual with respect to a particular product type, since training an individual about one type of product attributes and expectations does not train that individual with respect to all types of products attributes and expectations. Once the data is tagged or otherwise associated with a trained or untrained descriptor, the system may simply filter a query according to the trained/untrained characteristic to then find matches thereto and report the same (e.g. printing out a report, displaying information on a screen, generating a graphical representation).

The illustrated system 10 also tracks records of consumers using the system. Consumers may be users of the system and the system may have separate accounts for the various users thereof. The system may alternatively or in addition to such user accounts, include descriptors (e.g. name, id number) in association with collected data that matches with one or more specific consumers.

The illustrated system of processing data using a computing device 10 is in communication with a plurality of product user interface modules 25 and a plurality of consumer user interface modules 15 over a computerized network 38. The illustrated system 10 collects product data from the product user interfaces modules 25 in regards to product development by engineers and product developers and from the consumer user interface modules 15 in regards to consumer use and opinions. Such data may be collected manually, automatically, in real-time and the like and combinations thereof.

The illustrated system includes a user interface modules in communication with the modules and components of the system. The user interface module may be a graphical user interface module and may include devices and programming sufficient to communicate with a network, to display product data, consumer data, marketing data to the users and to receive input from the users. Generally, such may be in the form of a personal computer, dumb-terminal, smartphone, tablet, or the like, but other embodiments are contemplated. Such will generally include a processor, a display device (e.g. monitor, tv, touchscreen), an audio device (e.g. speaker, microphone), memory, a bus, a user input device (e.g. controller, keyboard, mouse, touchscreen), and a communication device (e.g. a network card, wireless transponder), each in communication with one or more of the others as appropriate for the function thereof, generally over the bus. There may be a plurality and a variety of such graphical user interface modules in communication with the system over the network, with some being for product developers and others being for consumers, marketers, engineers, chemists, technical professionals, etc. and combinations thereof. The user interface module is configured to provide one or more interfaces for accessing the computerized system over a computerized network. Such may include one or more graphical user interfaces that may be embodied in software instructions for controlling display on a display (such as but not limited to a TV, monitor, cell phone/tablet screen, etc.) and/or for routing signals from an input device (such as but not limited to a keyboard, touchscreen, mouse, etc.) such that a user may perform data entries or queries in the computerized system, suggestions or recommendations, and receive data information therefrom. Such may be embodied in one or more user interfaces that permit browsing of the computerized system. Such may be embodied in one or more user interfaces that permit service personnel or administrators to make adjustments, changes, and otherwise provide product data or product updates to the computerized system. Such may be embodied in one or more user interfaces that permit review of data from the system, such as but not limited to template data, product data, user and consumer data, management data, etc.

The following is a non-limiting prophetic examples using generalized data of report from a system as described herein:

Report 1 (generated by entering instrumental data associated with viscosity, root penetration, and rinse speed and then requesting best match data associated with the demographics described below)

Product A

In Chicago, among women between the ages of 35-44, this product is likely to be described as being: raspy feel, too thin product consistency, and moderate rate of penetration.

In California, among women between the ages of 19-29, this product is likely to be described as being: smooth feel, just right product consistency, and moderate rate of penetration.

Product B

In Chicago, among women between the ages of 35-44, this product is likely to be described as being: shiny, non-greasy, and lightweight.

In California, among women between the ages of 19-29, this product is likely to be described as being: shiny, greasy, and heavy weight.

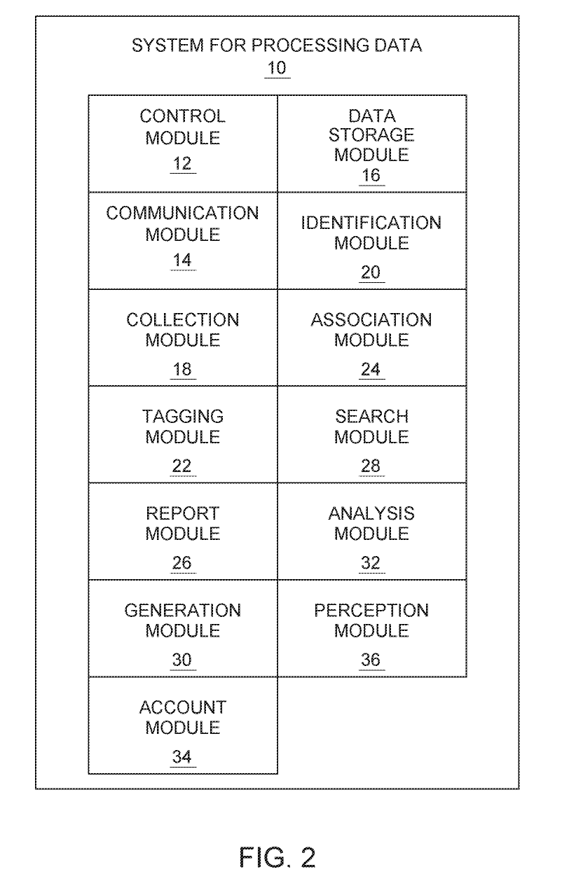

FIG. 2 is a module diagram of a system of processing data using a computing device, according to one embodiment of the invention. There is shown a system of processing data using a computing device 10 including a control module 12, a communication module 14, a data storage module 16, an identification module 20, a collection module 18, an association module 24, a tagging module 22, a search module 28, a report module 26, an analysis module 32, a generation module 30, a perception module 36, and an account module 34. Each of the illustrated modules are functionally coupled to other modules described herein as needed to perform the functions described herein.

In an effort to promote a successful product launch, especially for hair care products, like conditioner, shampoo, hair gel, etc., testing is often conducted to confirm claims, positioning, performance, etc. This testing can be conducted by in vivo (i.e. inside the normal biological context, e.g. testing on heads of people) and/or in vitro (i.e. outside the normal biological context, e.g. testing on hair samples). The illustrated system 10 allows a person or company an opportunity to automatically correlate such studies with consumer insights. The system 10 may create/store/identify a baseline understanding of consumer perception across various demographics, geographies, firmographics, and/or etc. using studies. Such demographics, etc. may include information/factors regarding location, location humidity data, climate, cultural influences, locational interest in particular product types and/or categories, ethnicity, age, gender, economic status, level of education, religion, grooming habits, income level, income level during formative years, etc. The baseline may be developed by analysis of such studies and may be indexed within the system according to one or more factors. In operation, the system may automatically gather data from one or more product studies and/or may receive a technical report that may be based on one or more product studies.

The system 10 may automatically apply one or more sets of information according to indexed factors to the technical report and/or study data and/or may automatically append/amend or otherwise manipulate the report/data and/or may generate a report wherein the relevance of such to the information set is signified in the same and/or communicated in language that is relevant to the information set (e.g. the product is described in a way that the selected demographic/geographic/firmographic would describe the product and/or the relative importance and good/bad value is communicated in the amended/appended/generated report).

The illustrated system 10 is configured to help product developers to interpret technical studies in a simpler way that incorporates expected consumer perceptions, so that the product developers may create better and more appropriate products for the consumers. The system 10 is configured to provide computerized assimilation/emulation of technical studies, such as invitro and invivo data analysis. The system 10 adds a layer of perception to the strict definition based studies so that the information is more accessible to people who have varying perception filters. The system 10 includes a database with information pertaining to consumer perception related to key attributes as related to particular products (e.g. hair care) that may be indexed according to geographic indicators, ethnicity, grooming habits and other factors that have a strong impact on their perception filters of the subject matter (a particular type of product). The system 10 includes a database including invitro data taken across those same index factors. The system may also use invivo focus group data that may be a collection of sensorial information and self-application feedback information. The system 10 takes the information in the databases and uses that to automatically generate rules (and/or the rules may be hard coded through expert analysis) for automatically altering the presentation of technical data to match particular selected index factors. The system 10 has a user interface usable by individuals such as but not limited to technical and/or marketing professionals in a company so that the users may speak to each other more effectively and may more easily understand what changes/adjustments may need to be made to their products. The system 10 may receive aggregate index information and generate reports that automatically analyze and generate reports on the aggregate and how different aspects for the aggregate would see the product.

According to one embodiment of the invention, there is a system of processing data using a computing device 10 to help create products more easily, to help create better products, provide more customization, to respect diversity of consumer groups, be less expensive, to increase probability of continued use of products, to enable better marketing materials, to enable more accurate marketing materials, to suggest marketing language, to suggest additional product types/categories, to eliminate wasteful SKUs, to create opportunities for targeted formulations, and/or to allow stylists to generate very customized suggestions for products.

According to one embodiment of the invention there is a system of processing data using a computing device 10 a control module 12 that provides operational instructions and commands to the modules and components of the system. The control module 12 is in communication with the modules and components of the system 10 (and/or other modules described herein) and provides managerial instructions and commands thereto. The source of such instructions/commands may be from one or more other modules described herein and/or through interactions between one or more other modules described herein. The control module 12 sets parameters and settings for each module and component of the system. Non-limiting examples of a control module may be a control module described in U.S. Pat. No. 5,430,836, issued to Wolf et al.; or a control module described in U.S. Pat. No. 6,243,635, issued to Swan et al. which are incorporated for their supporting teachings herein. A control module may include but is not limited to a processor, a state machine, a script, a decision tree, and the like.

The illustrated system 10 includes a communication module 14, such as a network card, system bus, or wireless communication module, and communicates with a computerized network. The communication module 14 provides communication capabilities, such as wireless communication, to the modules and components of the system 10 and the components and other modules described herein. The communication module 14 provides communication between a wireless device, such as a mobile phone, and a computerized network and/or to facilitate communication between a mobile device and other modules described herein. The communication module 14 may have a component thereof that is resident on a user's mobile device or on a user's desktop computer. Non-limiting examples of a wireless communication module may be but not limited to: a communication module described in U.S. Pat. No. 5,307,463, issued to Hyatt et al.; or a communication module described in U.S. Pat. No. 6,133,886, issued to Fariello et al., which are incorporated for their supported herein.

The illustrated system of processing data using a computing device 10 includes a data storage module 16 in communication with the modules and components of the system 10. The data storage module 16 collects and store data for each of the modules of the system 10. The data storage module 16 is in communication with the various modules and components of the system 10 over a computerized network and stores data transferred there through. The data storage module 16 stores data transferred through each of the modules of the system 10, thereby updating the system with up to date data and real time consumer data and product user data. The data storage module 16 securely stores user data along with data transferred through the system.

The data storage module 16 include a product data storage module is in communication with the modules and components of the system 10. The product data storage module is configured to store product data, such as for hair care products that stores data and standards related to shine, oiliness, breakage, conditioning, smoothness, moisturization, etc. The product storage module includes characteristics of the products alone as well as how the product influences the hair during and after use.

The illustrated data storage module 16 includes a report storage module in communication with the modules and components of the system 10, and is configured to store and manage reports generated by a generation module 30. The report storage module is configured to store previous product analysis reports along with corresponding marketing data related to the product, for future use with a particular group, demographic, age group, etc. Non-limiting examples of a report storage module may be a database and/or data files and the memory storage device may be, but is not limited to, hard drives, flash memory, optical discs, RAM, ROM, and/or tapes. Data storage module 16 may be databases and/or data files and the memory storage device may be, but is not limited to, hard drives, flash memory, optical discs, RAM, ROM, and/or tapes. A non-limiting example of a data base is Filemaker Pro 11, manufactured by Filemaker Inc., 5261 Patrick Henry Dr., Santa Clara, Calif., 95054. Non-limiting examples of a data storage module may include: a HP Storage Works P2000 G3 Modular Smart Array System, manufactured by Hewlett-Packard Company, 3000 Hanover Street, Palo Alto, Calif., 94304, USA; or a Sony Pocket Bit USB Flash Drive, manufactured by Sony Corporation of America, 550 Madison Avenue, New York, N.Y., 10022.

The illustrated system 10 includes a perception module 36 configured to store and/or index demographics, ethnicity, grooming habits, etc. and how they relate to product perceptions of key product characteristics. The perception module 36 is in communication with the modules and components of the system 10. The perception module 36 stores language used by product developers and marketers to successfully market new products to consumers. Non-limiting examples of a perception storage module may be a HP Storage Works P2000 G3 Modular Smart Array System, manufactured by Hewlett-Packard Company, 3000 Hanover Street, Palo Alto, Calif., 94304, USA; or a Sony Pocket Bit USB Flash Drive, manufactured by Sony Corporation of America, 550 Madison Avenue, New York, N.Y., 10022.

The illustrated system of processing data using a computing device includes an analysis module 32 in communication with the modules and components of the system 10. The analysis module 32 includes executable information regarding product data, characteristics, filters, traits, etc. and/or user data. The analysis module 32 analyzes report requests in light of the data and generates additional report information to the user. The analysis module 32 is in communication with the modules and components of the system as appropriate to perform its function(s). The analysis module 32 analyzes collections of product data according to the executable information regarding product description and consumer information, such as metadata. The analysis module 32 analyzes stored metadata from the data storage module and the other modules of the system and thereby generates a report for the stylist/consumer and/or for development/design/marketing of the product tailored for a specific user or consumer. The analysis module 32 is configured to analyze consumer data and product data from the perception storage module and the product data storage module customized by a user to determine product feasibility and/or language that is appropriate to effectively market the product to consumers. Non-limiting examples of analysis module may be a data analysis system as described in U.S. Patent Publication No.: 2012/0290576; or an analysis system as described in U.S. Patent Publication No.: 2011/0208519, which are incorporated for their supporting teachings herein. Non-limiting examples of a knowledge base module may be as described in U.S. Pat. No. 6,064,971 by Hartnett and U.S. Pat. No. 5,257,185 by Farley, which are incorporated for their supporting teachings herein.

The illustrated system of processing data using a computing device includes a generation module 30 in communication with the modules and components of the system 10. The generation module 30 is configured to assimilate information from the analysis module 32 into reports in an appropriate and accessible manner. The generation module 30 is configured to automatically generate one or more reports, including but not limited to product analysis information, consumer information, product development information, marketing information from the system. The generation module 30 is configured to set parameters, criteria, characteristics, settings, preferences, listings, categories, groupings, etc. for a report, for products to be reviewed by how they rated with the other consumers, products, etc. Non-limiting examples of a generation module may be a system as described in U.S. Pat. No. 7,711,581; or a report generation module as described in U.S. Patent Publication No.: 2012/0284188, which are incorporated for their supporting teachings herein.

The illustrated system of processing data using a computing device 10 includes an identification module 20. The identification module 20 is in communication with the modules and components of the system 10. The identification module 20 for identifying whether the collected data is instrumental data or human-descriptive data. The identification module 20 identifies whether the collected data is from the product developers or from consumers, and thereby designates whether the data is instrumental data or human-descriptive data. Non-limiting examples of an identification module 20 may be a script for parsing data to identify data type (e.g. numeric, integer, text) tp identify the data based on inherent characteristics, a query instruction to look for a particular field within a record, a data entry module that enforces identification of data upon entry into the system, and/or a survey module that asks a user to enter what type of data the data represents and the like and combinations thereof.

The illustrated system of processing data using a computing device 10 includes a collection module 18 in communication with the modules and components of the system 10. The collection module 18 automatically collects data on the user, products, merchants, social interactions, etc. and stores the data therein or in the data storage module 16. The collection module 18 is in communication with a plurality of user interface modules and a plurality of product user interface modules, along with the modules and components of the system 10. The collection module 18 is configured to collect and store data for each of the plurality of user interface modules and each of the plurality of product user interface modules along with each user account associated therewith. The collection module 18 is in communication with the various modules and components of the system 10 and configured to store data transferred there through. The collection module 18 is configured to store data transferred through each of the user interface modules and product user interface modules, thereby updating the system with up to data and real time product data. The collection module 18 is configured to securely store shopping and financial data associated with the user or user account data along with data transferred therethrough. Data collection modules may be databases or data files and the memory storage device may be hard drives or tapes. A non-limiting example of a data base is Filemaker Pro 11, manufactured by Filemaker Inc., 5261 Patrick Henry Dr., Santa Clara, Calif., 95054. Non-limiting examples of a collection module may include: a HP Storage Works P2000 G3 Modular Smart Array System, manufactured by Hewlett-Packard Company, 3000 Hanover Street, Palo Alto, Calif., 94304, USA; or a Sony Pocket Bit USB Flash Drive, manufactured by Sony Corporation of America, 550 Madison Avenue, New York, N.Y., 10022.

The illustrated system of processing data using a computing device 10 includes an association module 24. The association module 24 is in communication with the modules and components of the system 10. The association module 24 associates demographic information with the selected product data. The association module 24 determines which selected product data is associated with the demographic data of consumers. Non-limiting examples of an association module may be a survey module for incorporating data within a database, a database module, a data management system for compiling structured data and the like and combinations thereof.

The illustrated system of processing data using a computing device 10 includes a tagging module 22. The tagging module 22 is in communication with the modules and components of the system 10. The tagging module 22 tags the collected product data with a tag based on whether it is instrumental data or human-descriptive data. The tagging module is in communication with the data storage module 16 and configured to store tagged product data. Non-limiting examples of a tagging module may be a survey module for incorporating data within a database, a database module, a data management system for compiling structured data and the like and combinations thereof.

The illustrated system of processing data using a computing device 10 includes a search module 28. The search module 28 is in communication with the modules and components of the system 10. The search module 28 searches for similarities with collected data from a data pool storing trained/un-trained, attributes, instrumental, human—descriptive and demographic data. The search module 28 searched through the data storage module and the product and consumer data stored therein to provide a best match of the collected data. Non-limiting examples of a search module may be a database query module, a matching engine (intelligent/fuzzy or otherwise), or the like and combinations thereof.

The illustrated system of processing data using a computing device 10 includes an account module 34. The account module 34 is in communication with the modules and components of the system 10 and is configured to manage and store and track consumer data. The account module 34 is configured to store consumer and product metadata and account data, based upon consumer input. Non-limiting examples of an account module 34 may be an account including demographic information about a consumer or user as well as preference information about a user that is associated therewith. Such information may include preferred products, product use, and product preferences and combinations thereof. Such may be embodied in a database or other data structure/hierarchy such that the data associated with each user may be used by one or more modules described herein and/or may be altered and/or added to by one or more modules described herein. The account module 34 is configured to store personal and product data relating to the system 10. Non-limiting examples of an account module may be an account management module as described in U.S. Patent Publication No.: 2003/0014509; or a management module as described in U.S. Pat. No. 8,265,650, which are incorporated for their supporting teachings herein.

The illustrated system of processing data using a computing device 10 includes a processing module 38 for processing data transferred and used throughout the system 10. The processing module 38 includes executable information regarding product data, consumer characteristics and data along with account data. The processing module 38 is in communication with the modules and components of the system 10 as appropriate to perform its function(s). The processing module 38 analyzes collections of consumer and product data according to the executable information regarding product and demographic data and stats, such as metadata. The processing module 38 analyzes stored metadata from the data storage module 16 thereby generating an association or tag that combines product data along with demographic data and consumer use data. Such may be performed automatically using scripts, functions, matching engines, data conditioning modules, data processing modules and the like and combinations thereof. Non-limiting examples of a processing module may be a data analysis system as described in U.S. Patent Publication No.: 2012/0290576; or an analysis system as described in U.S. Patent Publication No.: 2011/0208519, which are incorporated for their supporting teachings herein. Non-limiting examples of a knowledge base module may be as described in U.S. Pat. No. 6,064,971 by Hartnett and U.S. Pat. No. 5,257,185 by Farley, which are incorporated for their supporting teachings herein.

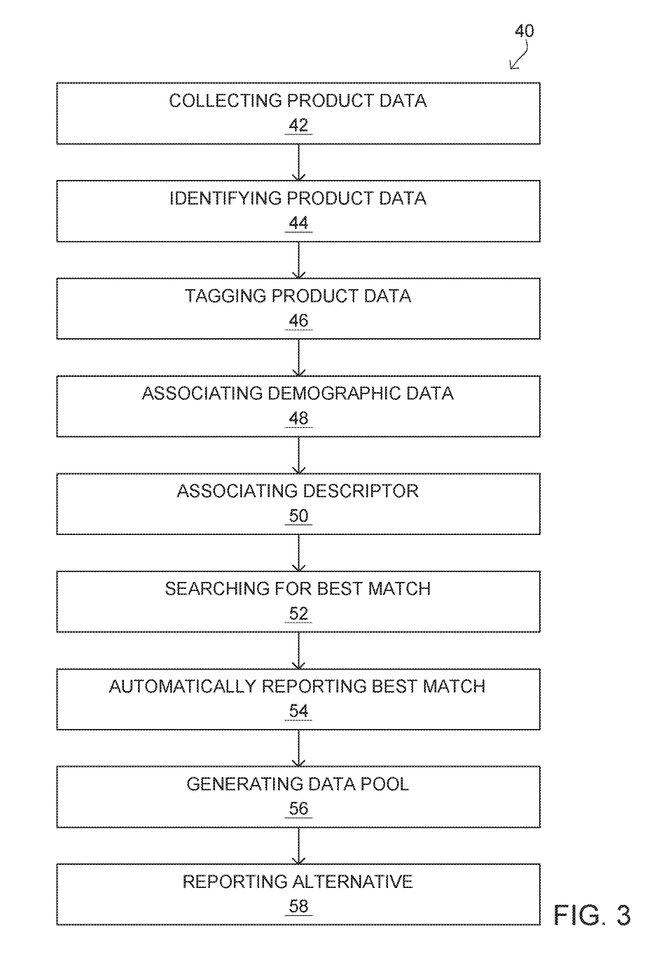

FIG. 3 is a method of processing data using a computing device, according to one embodiment of the invention. There is shown a method of processing data using a computing device 40.

The illustrated method of processing data using a computing device 40 includes the step of collecting product data regarding one or more product formulations according to one or more attributes and associating that product data with corresponding product formulations and attributes, wherein the attributes correspond to attribute categories stored in a computing device 42. The step of collecting product data 42 includes collecting instrumental data and further comprising the steps of: producing a plurality of product formulations on which instrumental data is collected; and automatically reporting best match data in a comparison format for the plurality of product formulations.

The method of processing data using a computing device 40 includes the step of identifying whether the collected product data is instrumental data or human-descriptive data 44. The method 40 includes the step of tagging the collected product data with a tag based on whether it is instrumental data or human-descriptive data 46.

The method of processing data using a computing device 40 includes the step of associating demographic information with the collected product data 48. The step of associating demographic information 48 includes the step of selecting demographic information if it is instrumental data and collecting demographic information if it is human-descriptive data. Demographic information may include ethnicity, cultural association, race, location, age, and gender. The method 40 includes associating a trained or un-trained descriptor with the collected product data 50. The method 40 includes the step of searching for a best match for the collected data in a data pool matching trained/un-trained, attributes, and demographic data while matching the opposite of instrumental and human-descriptor 52.

The method of processing data using a computing device 40 includes the step of automatically reporting the best match 54. The method 40 includes the step of generating the data pool by surveying a group of people with respect to their trained/un-trained descriptions related to specific attributes 56. The method 40 includes the step of reporting together with the best match an alternative match that is the alternative of trained/un-trained 58.

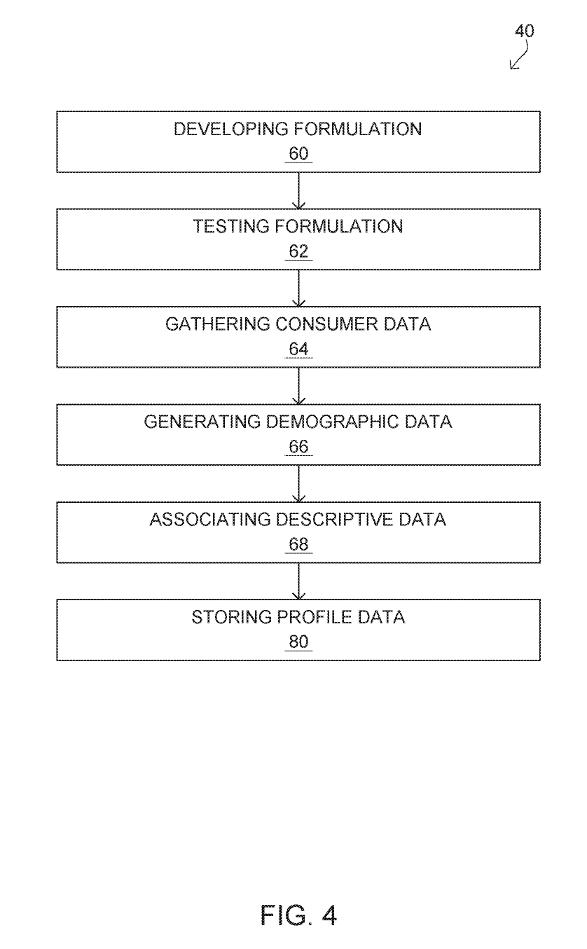

FIG. 4 is a method of processing data using a computing device, according to one embodiment of the invention. There is shown a method of processing data using a computing device 40.

The illustrated method of processing data, using a processor, over a computerized network 40. The method 40 includes the step of developing a consumer product formulation 60. The method 40 includes the step of testing the consumer product formulation to obtain instrumental data therefrom 62. The method 40 includes gathering human-descriptive data from consumers such that the human-descriptive data is associated with instrumental data categories 64. The method 40 includes the step of gathering demographic data from consumers from which human-descriptive data is gathered 66. The method 40 includes the step of associating human-descriptive data with the obtained instrumental data and the demographic data, thereby generating consumer profile data 68. The method 40 includes storing the consumer profile data 80.

According to one embodiment of the invention, there is a method of processing data, using a processor, over a computerized network 40 including the step of processing a second consumer product through a system of processing data, including a collection module for collecting product data regarding one or more product formulations according to one or more attributes. Collecting product data includes collecting instrumental data and further may comprise the steps of producing a plurality of product formulations on which instrumental data is collected. The method includes automatically reporting best match data in a comparison format for the plurality of product formulations.

The method of processing data, using a processor, over a computerized network 40 includes an identification module for identifying whether the collected data is instrumental data or human-descriptive data; a tagging module for tagging the collected product data with a tag based on whether it is instrumental data or human-descriptive data.

The method of processing data, using a processor, over a computerized network 40 includes an association module for associating demographic information with the selected product data. The step of associating demographic information may include the step of selecting demographic information if it is instrumental data and collecting demographic information if it is human-descriptive data

The method of processing data, using a processor, over a computerized network 40 includes a search module for searching for a best match for the collected data from a data pool, which includes the consumer profile data, matching trained/un-trained, attributes, and demographic data while matching the opposite of instrumental and human-descriptive data.

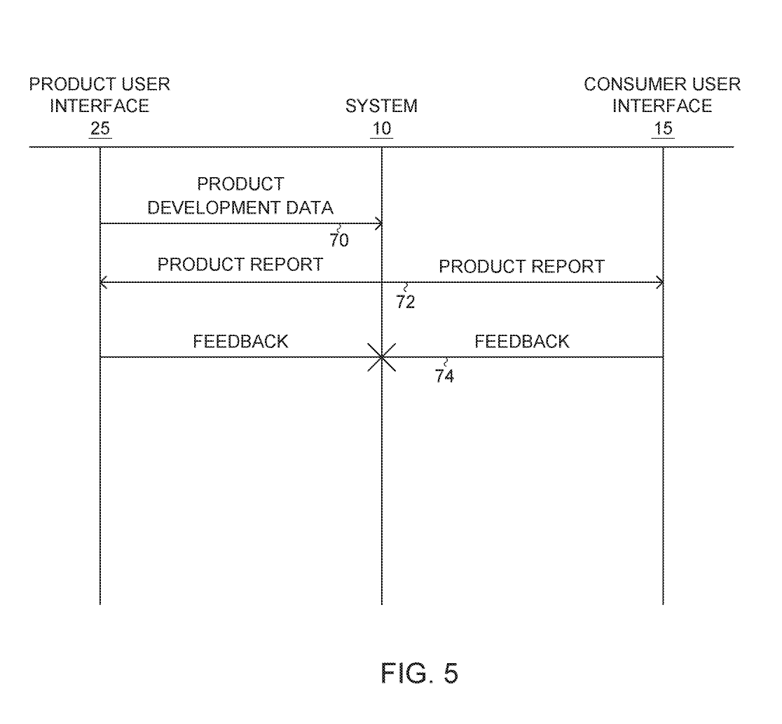

FIG. 5 is a sequence diagram of a method of processing data using a computing device, according to one embodiment of the invention. There is shown a system for processing data using a computing device in communication with a pair of user interface modules used by users, including but not limited to technical professionals, marketing professionals, business professionals, stylists, consumers, etc. Wherein the system only interacts with one or the other of the product developer and the consumer, the other may be left out of the sequence.

The illustrated sequence diagram shows product developer user interface 25 sending product development data 70 to a system of processing data using a computing device 10 including data pertaining to invivo and invitro studies, such as geographic indicators, demographics, ethnicity, grooming habits and other factors. Such may be performed by the user selecting one or more demographic/etc. factors according to which the data/report is to be analyzed and amended/etc. The user may select multiple parallel factors (e.g. analyzing the same data according to two different geographic locations) and/or sets of factors (e.g. analyzing the same data according to a particular religious factor among a particular age set while simultaneously also doing so according to a particular ethnicity among a particular location). The consumer user interface 15 provides information to the system about such selections and allows the user to input/upload the same to the system 10. The system may be distributed across a network.

The system 10 then analyzes the data and automates the assimilation of technical studies for a consumer and for product developers for future products. Such may be accomplished by associating particular levels/ranges of particular characteristics reported within the studies with language, associations, feelings, needs, desires, expectations, and the like stored and associated with particular groups, demographics, etc. As a non-limiting example, an in vitro study of a conditioner may report a particular Combing Force value which may be perceived as negative by a particular demographic set and expressed by the set as being Too Heavy, while another demographic set may perceive that same value as being positive and express that as being Luxurious; accordingly, the report that is amended/appended/generated when applied to the first group may report the value and then highlight the number reported in red (to signify negative) and follow the number with the phrase “Too Heavy;” in a similar non-limiting example when applied to the second group the report that is automatically generated may convert the data values into sentences with the sentence associated with the Covering Ability reading “We expect this group to enjoy the covering ability of the product and to describe the product as being “luxurious” and therefore we recommend that the marketing materials use this word as it will be positively consistent with the target demographic experience and it is therefore likely to promote spontaneous word of mouth marketing.”

The system 10 automatically sends out a product report 72 including language specific to a consumer and a product developer. Such may be accomplished by saving the report in a location where it is expected to be found by the intended recipient, emailing the report to the intended recipient, emailing the report to a review board/system/professional for further editing/review, emailing a link (automatically generated) to an intended recipient where it can be downloaded, etc.

The consumer and/or the product developer sends feedback 74 to the system to further assist in determining proper language for each report. Sections may be identified by the intended recipient and/or reviewer as being problematic, confusing, unexpected or otherwise not immediately usable/appropriate and the system may automatically store/track/analyze such feedback for improving the system.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A method of processing data using a computing device, comprising the steps of:
a) collecting product data regarding one or more product formulations according to one or more attributes and associating that product data with corresponding product formulations and attributes, wherein the attributes correspond to attribute categories stored in a computing device;
b) identifying whether the collected product data is instrumental data or human-descriptive data;
c) tagging the collected product data with a tag based on whether it is instrumental data or human-descriptive data;
d) associating demographic information with the collected product data;
e) associating a trained or un-trained descriptor with the collected product data; and
f) searching for a best match for the collected data in a data pool matching trained/un-trained, attributes, and demographic data while matching the opposite of instrumental and human-descriptor.

2. The method of claim 1, further comprising the step of automatically reporting the best match.

3. The method of claim 1, wherein the step of associating demographic information includes the step of selecting demographic information if it is instrumental data and collecting demographic information if it is human-descriptive data.

4. The method of claim 1, wherein demographic information includes ethnicity, cultural association, race, location, age, and gender.

5. The method of claim 1, wherein the step of collecting product data includes collecting instrumental data and further comprising the steps of:
producing a plurality of product formulations on which instrumental data is collected; and
automatically reporting best match data in a comparison format for the plurality of product formulations.

6. The method of claim 1, further comprising the step of generating the data pool by surveying a group of people with respect to their trained/un-trained descriptions related to specific attributes.

7. The method of claim 1, further comprising the step of reporting together with the best match an alternative match that is the alternative of trained/un-trained.

8. A system of processing data using a computing device, comprising:
a) a collection module for collecting product data regarding one or more product formulations according to one or more attributes;
b) an identification module for identifying whether the collected data is instrumental data or human-descriptive data;
c) a tagging module for tagging the collected product data with a tag based on whether it is instrumental data or human-descriptive data;
d) an association module for associating demographic information with the selected product data; and
e) a search module for searching for a best match for the collected data from a data pool matching trained/un-trained, attributes, and demographic data while matching the opposite of instrumental and human-descriptive data.

9. The system of claim 8, further comprising a report module for reporting a best match.

10. The system of claim 8, further comprising a generation module for generating the data pool by surveying a group of people with respect to their trained/untrained description related to specific attributes.

11. The system of claim 8, further comprising a perception storage module for tracking and storing consumer perceptions during use of the system.

12. The system of claim 8, further comprising a product data storage module for tracking and storing instrumental data.

13. The system of claim 8, further comprising an analysis and reporting module for generating reports for trained and untrained consumers.

14. The system of claim 8, further comprising an account module for tracking records of consumers using the system.

15. A method of processing data, using a processor, over a computerized network, comprising the steps of:
a) developing a consumer product formulation;
b) testing the consumer product formulation to obtain instrumental data therefrom;
c) gathering human-descriptive data from consumers such that the human-descriptive data is associated with instrumental data categories;
d) gathering demographic data from consumers from which human-descriptive data is gathered;
e) associating human-descriptive data with the obtained instrumental data and the demographic data, thereby generating consumer profile data; and
f) storing the consumer profile data.

16. The method of claim 15, further comprising the step of:
g) processing a second consumer product through a system of processing data, including:
i) a collection module for collecting product data regarding one or more product formulations according to one or more attributes;
ii) an identification module for identifying whether the collected data is instrumental data or human-descriptive data;
iii) a tagging module for tagging the collected product data with a tag based on whether it is instrumental data or human-descriptive data;
iv) an association module for associating demographic information with the selected product data; and
v) a search module for searching for a best match for the collected data from a data pool, which includes the consumer profile data, matching trained/un-trained, attributes, and demographic data while matching the opposite of instrumental and human-descriptive data.

17. The method of claim 16, further comprising the step of:
h) generating and reviewing reports on a consumer product based on best match data from the system of processing data.

18. The method of claim 17, wherein collecting product data includes collecting instrumental data and further comprising the steps of:
producing a plurality of product formulations on which instrumental data is collected; and
automatically reporting best match data in a comparison format for the plurality of product formulations.

19. The method of claim 18, further comprising the step of automatically reporting the best match.

20. The method of claim 19, wherein the step of associating demographic information includes the step of selecting demographic information if it is instrumental data and collecting demographic information if it is human-descriptive data.
